(19) United States
(12) Patent Application Publication
(10) Pub. No.: US 2012/0124514 A1
(43) Pub. Date: May 17, 2012

(54) PRESENTATION FOCUS AND TAGGING

(75) Inventor: Nino Yuniardi, Seattle, WA (US)

(73) Assignee: Microsoft Corporation, Redmond, WA (US)

(21) Appl. No.: 12/943,940

(22) Filed: Nov. 11, 2010

(51) Int. Cl. G06F 3/048

(52) U.S. Cl. 715/802

(57) ABSTRACT

Architecture that facilitates the directing of viewer focus on selected content in the presentation document. Focus is visually represented using a focus viewport, which provides a bounded area in which the content of focus is enhanced for viewing, while content outside the viewport is impaired from being viewed. Selecting on a particular point or location in the document automatically activates the focus viewport and applies focus (e.g., enlarged viewing) to an area proximate the selection point. The content selected for focus can be tagged as a landmark section, which is then stored with other content tagged as landmark sections, some or all of which can then be run as frames in a movie strip for continuous review.

### BACKGROUND

Ad hoc presentations can be challenging. When a presenter has multiple document sources, there is no easy way to retrieve and efficiently present documents without interrupting the flow of the presentation. Thus, the audience can become distracted by this disjointed flow.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates the directing of viewer focus on selected content in the presentation document. Focus is visually represented using a focus viewport, which provides a bounded area in which the content of focus is enhanced for viewing, while content outside the viewport is impaired from being viewed. Text is one example of the content, since the content can also include images, video clips, links, etc.

Selecting (e.g., clicking using a mouse) on a particular point or location in the document automatically activates the focus viewport and applies focus (bounds the selected location) to an area proximate the selection point. For example, selecting a point in a paragraph automatically applies focus to the paragraph in which the point exists and blurs content outside the viewport area. However, focus can also be configured to include a predefined number of lines of text above and/or below the selected point, rather than a unit of content such as a paragraph. Once established, the focus viewport can be expanded or reduced by selecting associated controls (e.g., an up arrow to expand or a down arrow to reduce the viewport area).

Additionally, the content selected for focus can be tagged as a landmark section. The landmark section can then be stored with other content tagged as landmark sections, some or all of which can then be run as frames in a movie strip (e.g., continuous). Tagging can be performed via a control (e.g., tear drop graphic) that marks the content as being desired to be included for subsequent review, separate from the untagged content. The chronological tagging of the content as landmark section automatically creates a movie sequence in the side pane, where the landmark sections are presented as thumbnail images.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented presentation system in accordance with the disclosed architecture.

FIG. 2 illustrates an exemplary focus viewport as applied to selected content in a user interface.

FIG. 3 illustrates a computer-implemented presentation method in accordance with the disclosed architecture.

FIG. 4 illustrates further aspects of the method of FIG. 3.

FIG. 5 illustrates a block diagram of a computing system that executes focusing/defocusing and tagging for an ad hoc presentation in accordance with the disclosed architecture.

### DETAILED DESCRIPTION

The disclosed architecture provides directed focus to selected portions of content in a presentation document. Focus is visually represented using a focus viewport, which provides a bounded area in which the selected content for focus is enhanced for viewing (e.g., enlarged), while content outside the viewport is impaired (e.g., reduced, blurred, blocked, etc.) from being viewed. The content selected for focus can be also tagged as a landmark section, and stored with other content tagged as landmark sections, some or all of which can then be run as frames in a movie strip (e.g., continuous).

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

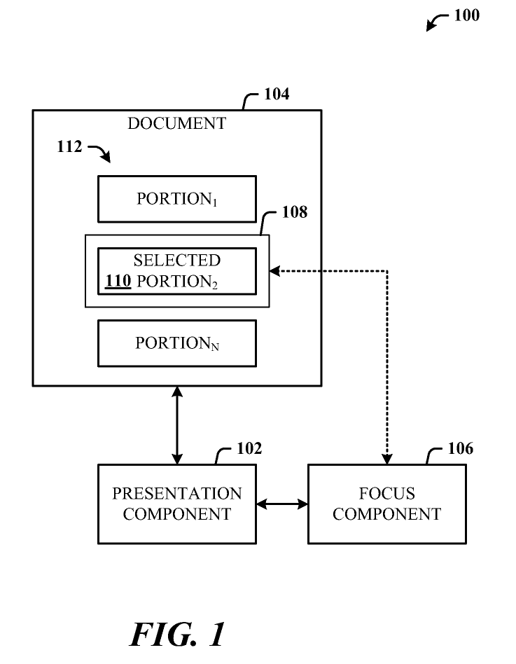

FIG. 1 illustrates a computer-implemented presentation system 100 in accordance with the disclosed architecture. The system 100 includes a presentation component 102 that presents a document 104 for an ad hoc presentation. The presentation component 102 can be a presentation application, for example, or other application suitable for presenting documents and data. The ad hoc presentation is unprepared or impromptu in contrast to prepared and organized presentations that may have been previously reviewed and tested, for example.

The system 100 also includes a focus component 106 that applies a focus viewport 108 on a selected portion 110 of content 112 of the document 104 being presented to enhance viewing of the selected portion 110. Note that the focus component 106 can be installed as a component separate from the presentation component 102, or as an integrated component of the presentation component 102.

The focus component 106 enables enlargement of content in the focus viewport 108 of the document 104. The focus component 106 also blocks content outside the focus viewport 108 from being viewed. The focus component 106 also enables enlargement in area of the focus viewport 108. The area dimensions can be enlarged in the length and/or the width, where the viewport 108 is of a rectangular geometry. (Note that other geometries can be employed, such as convex polygons, etc.)

The focus component 106 enables reduction in area of the focus viewport 108. When a rectangle, this reduction can be along the length and/or the width dimensions. The focus viewport 108 can be activated in response to selection on a location on the document 104. The location of selection is in the focus viewport 108 when activated. The focus component 106 enables tagging of the selected portion 110 for subsequent viewing. The tagged selected portion 110 becomes a frame of a movie sequence with other frames of other tagged portions that can be played back. The tagged portion 110 can be presented as a thumbnail image in a side panel of the user interface in which the document 104 is presented.

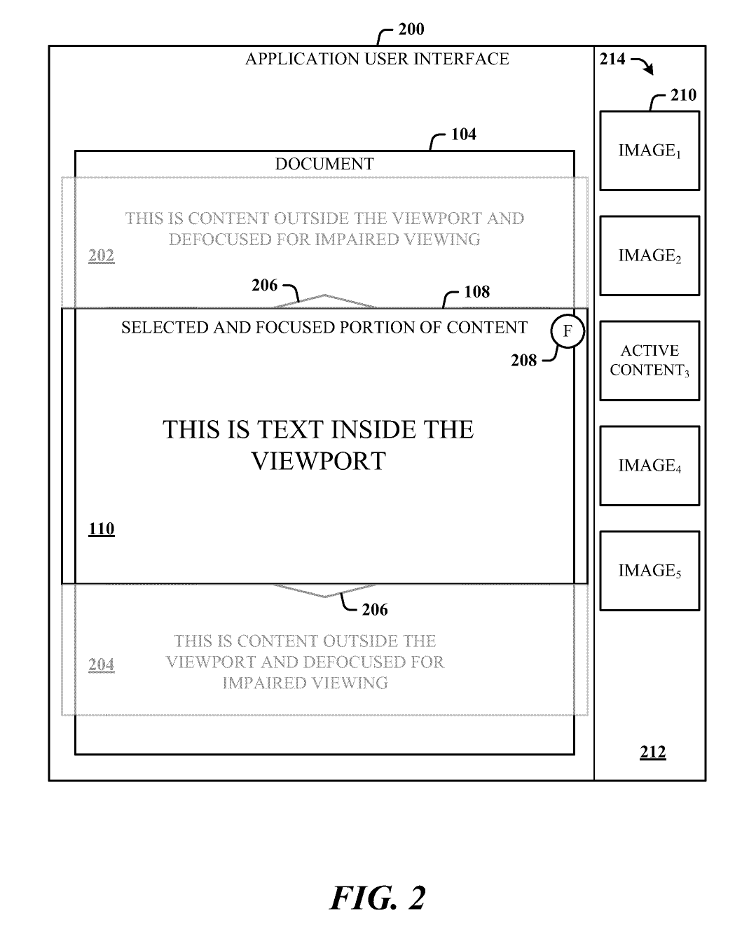

FIG. 2 illustrates an exemplary focus viewport 108 as applied to the selected portion 110 of content 112 in a user interface 200. The document 104 is retrieved and presented. The document 104 includes three sections of content, in this particular example; a first portion 202, the selected portion 110, and a third portion 204. In response to a selection action (e.g., click of mouse) in the content associated with the selected portion 110, the focus viewport 108 is created and applied thereto. Concurrently, the content associated with the first portion 202 and third portion 204 is defocused to impair viewing, using an impaired viewing technique, such as blurring, or as illustrated here, overlying a semi-transparent (or opaque) graphic on the unselected portions of the content.

It is within contemplation of the disclosed architecture that focus can be applied without defocusing the unselected portions of content, by enhancing the content in the viewport 108 differently than the content outside the viewport. For example, the selected portion of content can be increased on font size for text, and images can be increased in size for better improved viewing, while the content outside the viewport 108 can be changed to a different font, reduced font, highlighted with a darker or different color, etc.

The viewport 108 has associated therewith dimension (or size) controls 206 that when selected, can be dragged to increase or decrease the area of the viewport 108. For example, when dragging the upper control 206, the upper side (edge) of the viewport 108 can be moved up or down thereby setting the upper bound for the selected portion 110 of content 112. Similarly, when dragging the lower control 206, the lower side (edge) of the viewport 108 can be moved up or down thereby setting the lower bound for the selected portion 110 of content 112. Once the control 206 (upper or lower) is released, the content within the upper and lower bounds of the viewport 108 becomes the selected portion 110 of the content 112, and any content outside the viewport bounds becomes defocused.

Note that dimensional control of the viewport 108 need not be limited to the upper and lower edges, but can also be enabled by making a selection in a corner such that a drag-and-drop operation reduces or expands the viewport along both axes (the width and length dimensions). Accordingly, focus can be applied to small portions of content in a document formatted to include multiple columns of content. (In the document 104, there is only a single column of content.) Moreover, in multi-columned documents, the content can include an embedded image in a second column of a three-columned document, over which the viewport 108 can be applied for focus on the image and any associated image description text, for example. Thus, a snapshot of the selected content can include only the embedded image.

The viewport 108 can also include a frame control 208 the selection of which tags and captures the selected portion 110 of content 112 as an image, such as an associated image 210. The user can also drag in a webpage with active content, and capture (or snapshot) the desired content (some or all of the webpage) for insertion as part of the images 214, and playback. Additionally, subsequent selection of an image returns the user the content into focus in the viewport 108. This applies to the webpage as well, such that the user is then presented with active content which can be selectable as originally presented in the webpage.

All tagged portions of content can be presented in a side panel area 212 as a series of images 214 created as the content is tagged. The user can then alter the order of the images 214 to the desired sequence for playback as a movie or automated slide deck, for example.

In an alternative embodiment, the viewport 108 can be dragged (in a drag-and-drop operation commonly known by those skilled in the art) up or down over to change the bounding of currently selected and unselected content. When the user drops the viewport 108, the result is to automatically apply the focus to the content over which the viewport 108 is positioned, and defocuses content outside the viewport 108.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

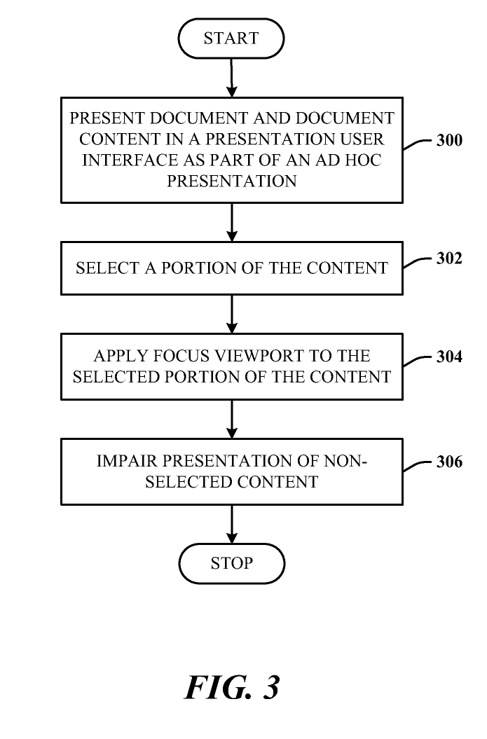

FIG. 3 illustrates a computer-implemented presentation method in accordance with the disclosed architecture. At 300, a document and document content is presented in a presentation user interface as part of an ad hoc presentation. At 302, a portion of the content is selected. At 304, a focus viewport is applied to the selected portion of the content. At 306, presentation of non-selected content is impaired.

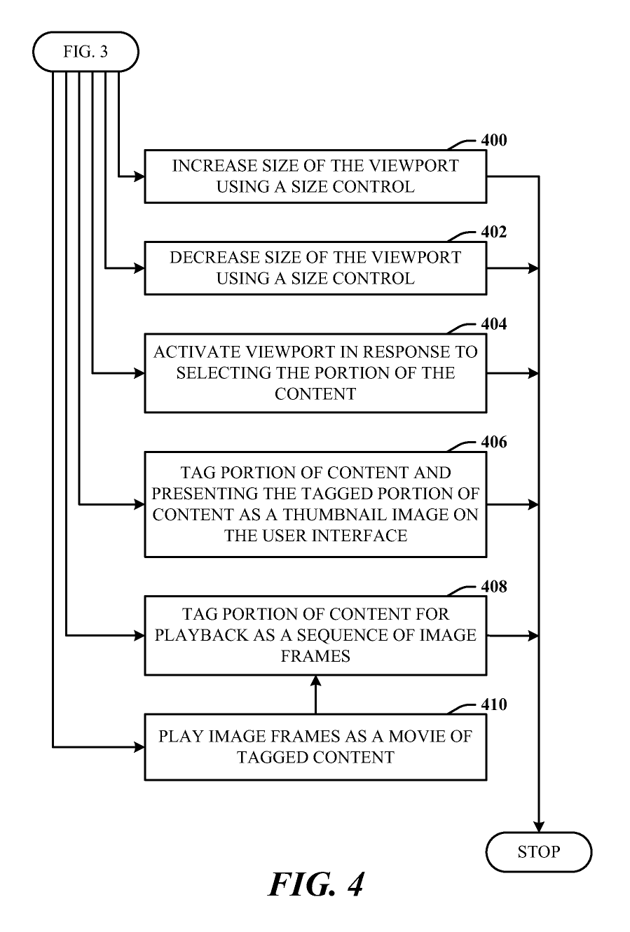

FIG. 4 illustrates further aspects of the method of FIG. 3. Note that the arrowing indicates that each block represents a step that can be included, separately or in combination with other blocks, as additional aspects of the method represented by the flow chart of FIG. 3. At 400, size of the viewport is increased using a size control. At 402, size of the viewport is decreased using a size control. At 404, the viewport is activated in response to selecting the portion of the content. At 406, the portion of content is tagged and the tagged portion of content is presented as a thumbnail image on the user interface. At 408, the portion of content is tagged for playback as a sequence of image frames. At 410, the image frames are played back as a movie of tagged content.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

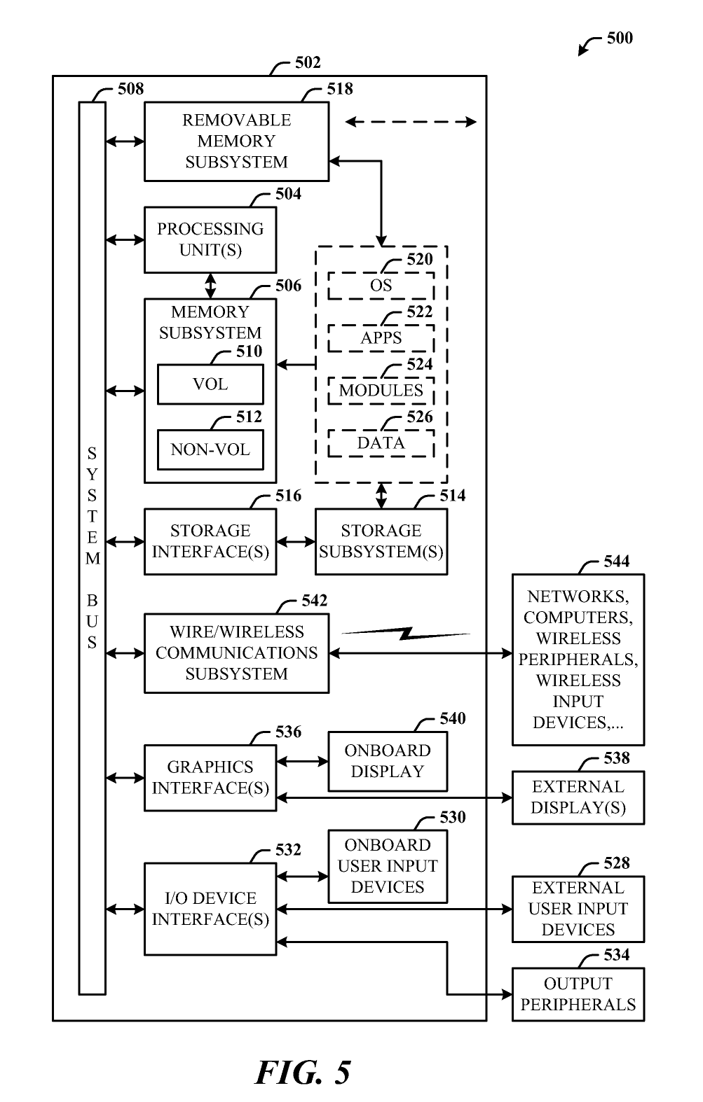

Referring now to FIG. 5, there is illustrated a block diagram of a computing system 500 that executes focusing/defocusing and tagging for an ad hoc presentation in accordance with the disclosed architecture. In order to provide additional context for various aspects thereof, FIG. 5 and the following description are intended to provide a brief, general description of the suitable computing system 500 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 500 for implementing various aspects includes the computer 502 having processing unit(s) 504, a computer-readable storage such as a system memory 506, and a system bus 508. The processing unit(s) 504 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 506 can include computer-readable storage (physical storage media) such as a volatile (VOL) memory 510 (e.g., random access memory (RAM)) and non-volatile memory (NON-VOL) 512 (e.g., ROM, EPROM, EEPROM, etc.). A basic input/output system (BIOS) can be stored in the non-volatile memory 512, and includes the basic routines that facilitate the communication of data and signals between components within the computer 502, such as during startup. The volatile memory 510 can also include a high-speed RAM such as static RAM for caching data.

The system bus 508 provides an interface for system components including, but not limited to, the system memory 506 to the processing unit(s) 504. The system bus 508 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 502 further includes machine readable storage subsystem(s) 514 and storage interface(s) 516 for interfacing the storage subsystem(s) 514 to the system bus 508 and other desired computer components. The storage subsystem(s) 514 (physical storage media) can include one or more of a hard disk drive (HDD), a magnetic floppy disk drive (FDD), and/or optical disk storage drive (e.g., a CD-ROM drive DVD drive), for example. The storage interface(s) 516 can include interface technologies such as EIDE, ATA, SATA, and IEEE 1394, for example.

One or more programs and data can be stored in the memory subsystem 506, a machine readable and removable memory subsystem 518 (e.g., flash drive form factor technology), and/or the storage subsystem(s) 514 (e.g., optical, magnetic, solid state), including an operating system 520, one or more application programs 522, other program modules 524, and program data 526.

The one or more application programs 522, other program modules 524, and program data 526 can include the entities and components of the system 100 of FIG. 1, the entities and components of the system 200 of FIG. 2, and the methods represented by the flowcharts of FIGS. 3 and 4, for example.

Generally, programs include routines, methods, data structures, other software components, etc., that perform particular tasks or implement particular abstract data types. All or portions of the operating system 520, applications 522, modules 524, and/or data 526 can also be cached in memory such as the volatile memory 510, for example. It is to be appreciated that the disclosed architecture can be implemented with various commercially available operating systems or combinations of operating systems (e.g., as virtual machines).

The storage subsystem(s) 514 and memory subsystems (506 and 518) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 502 and includes volatile and non-volatile internal and/or external media that is removable or non-removable. For the computer 502, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 502, programs, and data using external user input devices 528 such as a keyboard and a mouse. Other external user input devices 528 can include a microphone, an IR (infrared) remote control, a joystick, a game pad, camera recognition systems, a stylus pen, touch screen, gesture systems (e.g., eye movement, head movement, etc.), and/or the like. The user can interact with the computer 502, programs, and data using onboard user input devices 530 such a touchpad, microphone, keyboard, etc., where the computer 502 is a portable computer, for example. These and other input devices are connected to the processing unit(s) 504 through input/output (I/O) device interface(s) 532 via the system bus 508, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 532 also facilitate the use of output peripherals 534 such as printers, audio devices, camera devices, and so on, such as a sound card and/or onboard audio processing capability.

One or more graphics interface(s) 536 (also commonly referred to as a graphics processing unit (GPU)) provide graphics and video signals between the computer 502 and external display(s) 538 (e.g., LCD, plasma) and/or onboard displays 540 (e.g., for portable computer). The graphics interface(s) 536 can also be manufactured as part of the computer system board.

The computer 502 can operate in a networked environment (e.g., IP-based) using logical connections via a wired/wireless communications subsystem 542 to one or more networks and/or other computers. The other computers can include workstations, servers, routers, personal computers, microprocessor-based entertainment appliances, peer devices or other common network nodes, and typically include many or all of the elements described relative to the computer 502. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 502 connects to the network via a wired/wireless communication subsystem 542 (e.g., a network interface adapter, onboard transceiver subsystem, etc.) to communicate with wired/wireless networks, wired/wireless printers, wired/wireless input devices 544, and so on. The computer 502 can include a modem or other means for establishing communications over the network. In a networked environment, programs and data relative to the computer 502 can be stored in the remote memory/storage device, as is associated with a distributed system. It will be appreciated that the network connections shown are exemplary and other means of establishing a communications link between the computers can be used.

The computer 502 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented presentation system, comprising:
a presentation component that presents a document for an ad hoc presentation;
a focus component that applies a focus viewport on a selected portion of the document being presented to enhance viewing of the selected portion; and
a processor that executes computer-executable instructions associated with at least the focus component.

2. The system of claim 1, wherein the focus component enables enlargement of content in the focus viewport of the document.

3. The system of claim 2, wherein the focus component blocks content outside the focus viewport from being viewed.

4. The system of claim 1, wherein the focus component enables enlargement in area of the focus viewport.

5. The system of claim 1, wherein the focus component enables reduction in area of the focus viewport.

6. The system of claim 1, wherein the focus viewport is activated in response to selection on a location on the document, the location of selection is in the focus viewport when activated.

7. The system of claim 1, wherein the focus component enables tagging of the selected portion for subsequent viewing.

8. The system of claim 7, wherein the tagged portion becomes a frame of a movie sequence with other frames of other tagged portions that can be played back.

9. The system of claim 7, wherein the tagged portion is presented as a thumbnail image in a side panel.

10. A computer-implemented presentation system, comprising:
a presentation component that presents a document retrieved for an ad hoc presentation;
a focus component that applies a focus viewport on a selected portion of the document being presented to enhance viewing of the selected portion and impairs viewing of content outside the focus viewport, the focus viewport activated in response to selection on a location in the document; and
a processor that executes computer-executable instructions associated with at least the focus component.

11. The system of claim 10, wherein the focus component enables enlargement of content in the focus viewport of the document.

12. The system of claim 10, wherein the focus component enables enlargement in area of the focus viewport and reduction in area of the focus viewport.

13. The system of claim 10, wherein the focus component enables tagging of the selected portion for subsequent viewing with other tagged portions, the tagged portion becomes a frame of a movie sequence with other frames of other tagged portions that can be played back.

14. A computer-implemented presentation method, comprising acts of:
presenting a document and document content in a presentation user interface as part of an ad hoc presentation;
selecting a portion of the content;
applying a focus viewport to the selected portion of the content;
impairing presentation of non-selected content; and
utilizing a processor that executes instructions stored in memory to perform the acts of presenting, selecting, applying, and impairing.

15. The method of claim 14, further comprising increasing size of the viewport using a size control.

16. The method of claim 14, further comprising decreasing size of the viewport using a size control.

17. The method of claim 14, further comprising activating the viewport in response to selecting the portion of the content.

18. The method of claim 14, further comprising tagging the portion of content and presenting the tagged portion of content as a thumbnail image on the user interface.

19. The method of claim 14, further comprising tagging the portion of content for playback as a sequence of image frames.

20. The method of claim 19, further comprising playing the image frames as a movie of tagged content.
